(19) United States
(12) Patent Application Publication
(10) Pub. No.: US 2026/0361083 A1
(43) Pub. Date: Nov. 12, 2026

(54) POWER CONTROL CONCEPT FOR A VOLTAGE-INJECTING WIND POWER INSTALLATION

(71) Applicant: Wobben Properties GmbH, Aurich (DE)

(72) Inventors: Kaveh MALEKIAN BOROUJENI, Bremen (DE); Angelo MENDONCA, Wilhelmshaven (DE); Ingo MACKENSEN, Aurich (DE)

(21) Appl. No.: 19/670,890

(22) Filed: May 7, 2026

(30) Foreign Application Priority Data
May 8, 2025 (EP) 25175032.9

(51) Int. Cl. H02J 3/1885; H02J 3/001; H02J 101/28

(52) U.S. Cl. CPC H02J 3/1885; H02J 3/00125; H02J 2101/28

(57) ABSTRACT

The present disclosure relates to a method for controlling a wind power installation, comprising the steps of: actuating a converter of the wind power installation to generate an electric current by means of a generator, comprising: controlling a generator-side active rectifier of the converter; and controlling a grid-side active inverter of the converter; and feeding the electric current into an electrical supply grid to which the converter is connected, the generator-side active rectifier and/or the grid-side active inverter being controlled by means of a setpoint value (Pgen_AG_ref) for the power of an air gap of the generator of the wind power installation.

### TECHNICAL FIELD

The present disclosure relates to a method for controlling a wind power installation and to such a wind power installation.

### BACKGROUND

Usually, wind power installations are operated as wind farms on the electrical supply grid in so-called grid-following operation, i.e. the wind farm or the wind power installations of the wind farm are synchronized with or adjusted to match the electrical supply grid in terms of grid-side variables, such as, for example, voltage and frequency, in particular in order to feed a corresponding electrical power into the electrical supply grid.

Wind farms or the wind power installations of a wind farm are thus usually operated as current sources or in a current-injecting manner.

Due to such current-injecting or grid-following operation, however, the wind farms or wind power installations can only participate to a limited extent in supporting the electrical supply grid.

### SUMMARY

In order to allow improved support of the electrical supply grid by means of wind farms or wind power installations, the wind farms or wind power installations can, however, also be operated in so-called grid-providing or grid-forming operation, that is to say as grid formers, i.e. the wind farms or wind power installations of the wind farm inject a corresponding voltage and frequency into the electrical supply grid. The wind farm or the wind power installations of the wind farm are then operated as voltage sources or in a voltage-injecting manner.

The disadvantage of previously known grid-forming or voltage-injecting methods is the small amount of degrees of freedom in the grid-side control of the inverters of the wind power installations, which repeatedly lead to control-related problems, such as, for example, oscillation of the controllers due to interfering time constants or the like.

The European Patent Office searched the following prior art in the priority application for the present application: WO 2024/141141 A1, CN 115 378 054 A; Vijay Chand Ganti et al. “Quantitative Analysis and Rating Considerations of a Doubly Fed Induction Generator for Wind Energy Conversion Systems” (XP031784400) and EP 3 806 261 A1.

The object of the present disclosure is therefore to address at least one of the aforementioned problems. In one example, a method for controlling a wind power installation is to be provided, which allows improved grid-forming or voltage-injecting control of a wind power installation. At the very least, however, an alternative is to be provided.

Aspects of the present disclosure are directed to a method for controlling a wind power installation, comprising the steps of: actuating a converter of the wind power installation to generate an electric current by means of a generator, comprising: controlling a generator-side active rectifier of the converter; and controlling a grid-side active inverter of the converter; and feeding the electric current into an electrical supply grid to which the converter is connected, the generator-side active rectifier and/or the grid-side active inverter being controlled by means of a setpoint value for the power of an air gap of the generator of the wind power installation.

In one example, a method for controlling a wind power installation is thus proposed, which takes into account the air gap power of the generator, such that improved grid-forming or voltage-injecting control for the wind power installation is provided.

By virtue of the method described herein, the wind power installation is in one example, set up to act as a grid former or to perform voltage-injecting operation, that is to say to be used as a so-called grid forming means.

In one example, the generator-side active rectifier is controlled as a function of a power deviation.

The power deviation refers in one example to the generator-side active rectifier and is preferably derived from values of the DC link of the converter, such as, for example, the DC link voltage.

Preferably, the generator-side active rectifier is controlled as a function of an operating point for a DC link of the converter.

The operating point for the DC link can be specified, for example, by a superordinate control unit and/or relate to grid-side variables at the grid connection point of the wind power installation, such as, for example, the active power, the reactive power and/or the grid voltage.

By controlling the generator-side active rectifier by means of an operating point, it is in one example, possible to create a fast controller for the generator-side active rectifier, such as, for example, with a fast controller 330, as shown in FIG. 3. Preferably, a slower controller, such as, for example, the grid-side inverter controller 310 in FIG. 3, which takes into account the air gap power, is still subordinate to that fast controller 330 for the DC link.

Such a structure has the advantage that a grid fault can initially be reacted to quickly and then be adjusted more slowly. If, for example, a grid fault occurs, the grid-side power drops and the voltage in the DC link increases. That increase in the DC link voltage is then quickly compensated for by means of the method described herein, and the grid-side inverter power is accordingly adjusted more slowly.

Preferably, the method further comprises the step of: generating a setpoint value for a current of the generator-side active rectifier.

The method described herein thus operates in one example with current setpoint values for the converter, that is to say the generator-side active rectifier and/or the grid-side active inverter.

Preferably, both the generator-side active rectifier and the grid-side active inverter are controlled by means of the setpoint value for the power of an air gap of a generator of the wind power installations.

In one example, this means that both the generator-side active rectifier and the grid-side active inverter are controlled or adjusted taking into account the air gap power of the generator.

Preferably, the air gap power is estimated and/or determined from values or parameters of the controller.

Preferably, the grid-side active inverter is controlled as a function of a setpoint-actual difference, for example from one or the setpoint value and an actual value for the air gap power of the generator of the wind power installation.

Preferably, the grid-side active inverter is controlled as a function of a power deviation.

The power deviation refers in one example to the grid-side active inverter and is preferably derived from values of the air gap power.

Preferably, the grid-side active inverter is controlled taking into account converter losses and/or losses in the stator of the generator (estimated losses).

The converter losses are, for example, so-called switching losses or the like.

The losses in the stator are, for example, electrical and/or magnetic losses or the like.

Preferably, the method further comprises the step of: generating a setpoint value for a current of the grid-side active inverter.

Some aspects of the present disclosure are directed to a wind power installation, the wind power installation having a control unit which is set up to generate a setpoint current for the grid-side active inverter and a setpoint current for the generator-side active rectifier by means of a feed forward of the setpoint value.

A wind power installation is understood herein to mean in one example, a technical installation which converts the kinetic energy of the wind into electrical energy and feeds it into an electrical grid, such as, for example, a wind farm grid or an electrical supply grid. In this example, the wind power installation is designed in such a way that it is able to be used commercially on a large scale. Such a wind power installation is, for example, shown in FIG. 1 below.

In one example, the wind power installation has a generator-side active rectifier and/or an electrical phase section, as shown, for example, in FIG. 2 below.

Preferably, the control unit is set up to perform a method described herein and/or is designed, for example, as shown in FIG. 3 below.

### BRIEF DESCRIPTION OF THE DRAWINGS

The present disclosure is explained in more detail below on the basis of the accompanying figures, the same reference signs being used for identical or similar components or assemblies.

FIG. 1 schematically shows, by way of example, a perspective view of a wind power installation in one embodiment.

FIG. 2 schematically shows, by way of example, an electrical phase section of a wind power installation in one embodiment.

FIG. 3 schematically shows, by way of example, the structure of a control unit of a converter.

### DETAILED DESCRIPTION

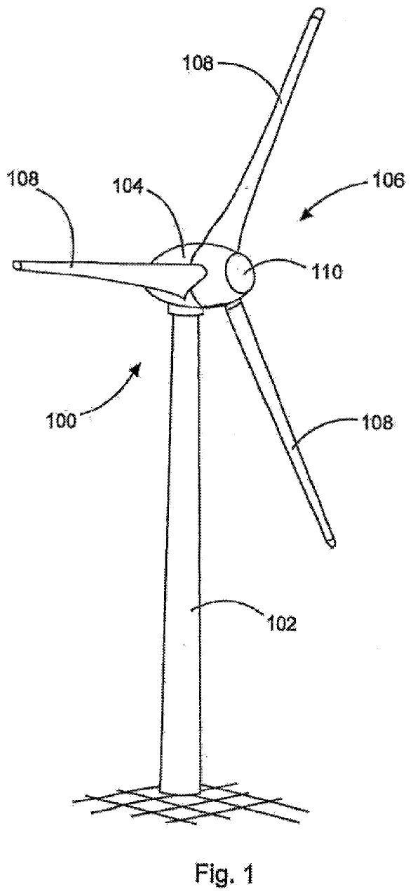

FIG. 1 schematically shows, by way of example, a perspective view of a wind power installation 100.

The wind power installation 100 is in the form of a buoyancy rotor with a horizontal axis and three rotor blades 200 on the windward side, in one example, in the form of a horizontal rotor.

The wind power installation 100 has a tower 102 and a nacelle 104.

An aerodynamic rotor 106 with a hub 110 is arranged on the nacelle 104.

Three rotor blades 108 are arranged on the hub 110, in one example, in a symmetrical manner with respect to the hub 110, preferably in a manner offset by 120°.

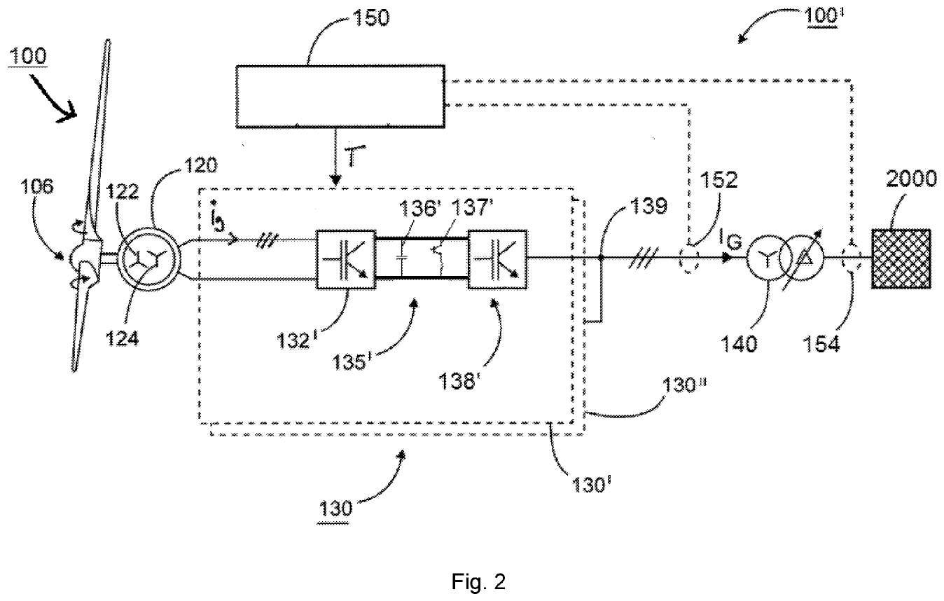

FIG. 2 schematically shows, by way of example, an electrical phase section 100′ of a wind power installation 100, as preferably shown in FIG. 1.

The wind power installation 100 has an aerodynamic rotor 106 which is mechanically connected to a generator 120 of the wind power installation 100.

The generator 120 is preferably in the form of a 6-phase synchronous generator, in one example, with two three-phase systems 122, 124 which are phase-shifted through 30° and are decoupled from one another.

The generator 120 is connected to an electrical supply grid 2000 or is attached to the electrical supply grid 2000 via a converter 130 and by means of a transformer 140.

In order to convert the electrical power generated by the generator 120 into a current iG to be fed in, the converter 130 has in each case at least one converter module 130′, 130″ for each of the electrical systems 122, 124, the converter modules 130′, 130″ being substantially structurally identical.

The converter modules 130′, 130″ have an active rectifier 132′ at a converter module input. The active rectifier 132′ is electrically connected to an inverter 137′, for example via a DC link 135′. A DC voltage capacitance 136′ and an electric chopper 137′ are also arranged in the DC link 135′. In this case, the DC voltage capacitance can be in the form of one or more DC link capacitors, for example.

The two three-phase systems 122, 124 which are decoupled from one another, in one example on the stator side, are combined, for example on the grid side, at a node 139 to form a three-phase overall system which carries the total current iG to be fed in.

In order to feed the total current iG to be fed in into the electrical supply grid 2000, a wind power installation transformer 150 is also provided at the output of the wind power installation, which transformer is preferably star-delta connected and connects the wind power installation 100 to the electrical supply grid 2000.

The electrical supply grid 2000, to which the wind power installation 100, 100′ is attached by means of the transformer 140, may be, for example, a wind farm grid or an electrical supply or distribution grid.

In order to control the wind power installation 100 or the electrical phase section 100′, a wind power installation control unit 150 is also provided.

In one example, the wind power installation control unit 150 is configured to set a total current iG to be fed in, in particular by actuating the generator-side active rectifiers 132′, 132″ or the grid-side active inverters 137′, 137″.

In this case, the generator-side active rectifiers 132′, 132″ and/or the grid-side active inverters 137′, 137″ are in one example actuated as described above or below, preferably by means of or on the basis of the driver signals T.

In one example, the converter 130 is operated in a voltage-injecting manner and/or is designed as a B2B converter (back-to-back converter).

The wind power installation control unit 150 is in one example also set up to measure the total current iG by means of a current measurement means 162. The currents of each converter module 137′ in each phase are preferably measured for this purpose.

In addition, the control unit also has voltage measurement means 164 which are set up to measure a grid voltage, in one example of the electrical supply grid 2000.

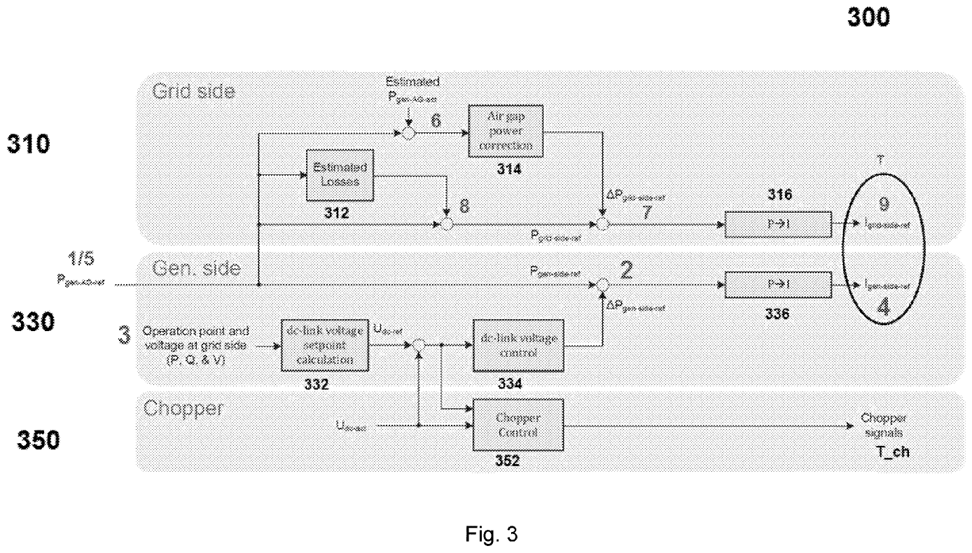

FIG. 3 schematically shows, by way of example, the structure 300 of a control unit of a converter, as illustrated in FIG. 2, for example.

The structure 300 essentially comprises a controller 310 for the grid-side inverter, a controller 330 for the generator-side rectifier, and a controller 350 for the chopper. Preferably, the controller 310 is executed sluggishly and/or the controller 330 is executed quickly. In one example, the controller 330 is executed faster than the controller 310.

The controller 310 for the grid-side inverter essentially comprises a module 312 for determining losses, a module 314 for correcting the air gap power, and a module 316 for generating a setpoint value Igrid_side_ref for the grid-side current.

The module 312 for determining losses ascertains a setpoint power Pgrid_side_ref from the setpoint value Pgen_AG_ref for the power of the air gap of the generator of the wind power installation, in one example taking into account the converter losses and/or the losses in the stator of the generator.

The module 314 for correcting the air gap power or the power setpoint value ascertains a power deviation ΔPgrid_side_ref from a deviation between the setpoint value Pgen_AG_ref for the power of the air gap and an estimated setpoint value Pest_gen_AG_ref for the power of the air gap. The module 314 thus corrects the power setpoint value of the grid-side active inverter, in one example due to a persistent deviation between the setpoint value and the estimated actual value of the air gap power.

The module 316 for generating a setpoint value Igrid_side_ref ascertains corresponding setpoint values for the grid-side active inverter from the power deviation ΔPgrid_side_ref and the setpoint power Pgrid_side_ref.

The module 316 can preferably include and/or perform a grid-forming control method, such as, for example, a virtual synchronous machine, which has a virtual lethargy and makes the controller 310 slower or more sluggish in comparison to the controller 330.

The controller 330 for the generator-side rectifier essentially comprises a module 332 for determining operating points, in one example for the DC link, a module 334 for controlling the DC link voltage, and a module 336 for generating a setpoint value Igen_side_ref for the generator-side current.

The module 332 for determining operating points ascertains a setpoint DC link voltage Udc_ref from the operating points of the wind power installation, which are specified, for example, by a superordinate controller, and any grid-side variables, such as active power P, reactive power Q and grid voltage V.

The module 334 for controlling the DC link voltage ascertains a power deviation ΔPgen_gen_ref from a difference between the setpoint DC link voltage Udc_ref and the actual DC link voltage udc_act.

The module 336 for generating a setpoint value Igen_side_ref ascertains corresponding setpoint values for the generator-side active converter from the power deviation ΔPgen_gen_ref and a setpoint value Pgen_AG_ref for the power of the air gap of the generator of the wind power installation.

The controller 350 for the chopper essentially comprises a module 352 for controlling the chopper, which generates corresponding chopper signals T_ch from the actual DC link voltage udc_act and a control deviation between the actual DC link voltage udc_act and the setpoint DC link voltage udc_ref.

The actual DC link voltage udc_act is additionally also applied to the controller 330 for the generator-side active rectifier.

Preferably, the chopper forms an essential part of the control system, which takes over at least the following tasks in the control described herein, namely: Protection against impermissible overvoltage in the DC link and/or negative energy buffers for managing the grid-side power reduction, e.g. as a result of a grid fault.

By controlling the generator-side active rectifier by means of an operating point, it is in one example possible to create a fast controller for the generator-side active rectifier, as shown by the controller 330 in FIG. 3, for example.

Preferably, a slower controller, such as, for example, the grid-side active inverter controller 310 in FIG. 3, which takes into account the air gap power, is still subordinate to that fast controller 330 for the DC link.

Such a structure has the advantage that a grid fault can initially be reacted to quickly and then be adjusted more slowly. If, for example, a grid fault occurs, the grid-side power drops and the voltage in the DC link increases. That increase in the DC link voltage is then quickly compensated for by means of the method described herein, and the grid-side inverter power is accordingly adjusted more slowly.

The converter is thus controlled in one example in a cascaded manner, and in one example such that the DC link voltage is initially controlled quickly and then the grid-side output power is adjusted more slowly.

### LIST OF REFERENCE SYMBOLS

100 Wind power installation
100′ Electrical phase section of the wind power installation
104 Nacelle of the wind power installation
106 Rotor of the wind power installation
108 Rotor blade of the wind power installation
110 Hub of the wind power installation
120 Generator of the wind power installation
122 First electrical system of the generator
124 Second electrical system of the generator
130 Converter, in particular power converter of a wind power installation
130′ Converter module for the first electrical system
130″ Converter module for the second electrical system
132 Active rectifier
132′ Active rectifier module for the first electrical system
132″ Active rectifier module for the second electrical system
135′ DC voltage for the first electrical system
136′ DC capacitance
137′ Electric chopper
138 Inverter
138′ Inverter module for the first electrical system
138″ Inverter module for the second electrical system
139 Node
140 Transformer of the wind power installation
150 Wind power installation control unit
152 Measurement means for measuring current and/or voltage
154 Measurement means for measuring current and/or voltage
300 View of a controller
310 Controller a grid-side active inverter
312 Module for determining losses
314 Module for correcting the air gap power
316 Module for generating a setpoint value
330 Controller for a generator-side active rectifier
332 Module for determining operating points
334 Module for controlling the DC link voltage
350 Controller for a chopper
352 Module for controlling the chopper
1000 Wind farm
1100 Wind farm grid for transporting power
1200 Grid connection point, especially of the wind farm
ig Total current of the generator
iG Total current of the converter
T Driver signals for the converter
T_ch Chopper signals
Igrid_side_ref Setpoint current for the grid side
Igen_side_ref Setpoint current for the generator side
Pgen_AG_ref Setpoint power for the air gap
Pest_gen_AG_ref Estimated power for the air gap
ΔPgrid_side_ref. Deviation from the setpoint power
Pgrid_side_ref Setpoint power for the grid side
ΔPgen_gen_ref. Deviation in the generator power
udc_act Actual DC link voltage
Udc_ref Setpoint DC link voltage
P Active power
Q Reactive power
V Grid voltage

1. A method for controlling a wind power installation, comprising:
actuating a converter of the wind power installation to generate an electric current using a generator, wherein actuating the converter includes:
controlling a generator-side active rectifier of the converter; and
controlling a grid-side active inverter of the converter; and
feeding the electric current into an electrical supply grid to which the converter is connected, wherein
at least one of the the generator-side active rectifier or the grid-side active inverter is controlled using a setpoint value (Pgen_AG_ref) for a power of an air gap of the generator of the wind power installation.

2. The method as claimed in claim 1, wherein
the generator-side active rectifier is controlled as a function of a power deviation (ΔPgen_side_ref).

3. The method as claimed in claim 1, wherein
the generator-side active rectifier is controlled as a function of an operating point (P, Q, V) for a DC link of the converter.

4. The method as claimed in claim 1, further comprising:
generating a setpoint value (Igen-side-ref) for a current of the generator-side active rectifier.

5. The method as claimed in claim 1, wherein
both the generator-side active rectifier and the grid-side active inverter are controlled using the setpoint value (Pgen_AG_ref) for the power of an air gap of a generator of the wind power installation.

6. The method as claimed in claim 1, wherein
the grid-side active inverter is controlled as a function of a setpoint-actual difference, from the setpoint value (Pgen_AG_ref) and an actual value (Pgen_AG_act) for the air gap of the generator of the wind power installation.

7. The method as claimed in claim 1, wherein at least one of:
the grid-side active inverter is controlled as a function of a power deviation (ΔPgrid_side_ref), or
the grid-side active inverter is controlled taking into account at least one of converter losses or losses in a stator of the generator.

8. The method as claimed in claim 1, wherein
negative energy buffer is provided for managing a grid-side power reduction, the negative energy buffer being a chopper in a DC link of the converter.

9. The method as claimed in claim 1, further comprising:
generating a setpoint value (Igen-side-ref) for a current of the grid-side active inverter.

10. A wind power installation comprising:
a converter; and
a controller configured to:
generate a setpoint current for a grid-side active inverter (Igen-side-ref) of the converter; and
generate a setpoint current for a generator-side active rectifier (Igen-side-ref) of the converter using a feed forward of a setpoint value (Pgen_AG_ref) for a power of an air gap of a generator of the wind power installation.

11. (canceled)

12. The wind power installation as claimed in claim 10, wherein the generator-side active rectifier is controlled as a function of a power deviation (ΔPgen_side_ref).

13. The wind power installation as claimed in claim 10, wherein the generator-side active rectifier is controlled as a function of an operating point (P, Q, V) for a DC link of the converter.

14. The wind power installation as claimed in claim 10, wherein the controller is further configured to generate a setpoint value (Igen-side-ref) for a current of the generator-side active rectifier.

15. The wind power installation as claimed in claim 10, wherein both the generator-side active rectifier and the grid-side active inverter are controlled using the setpoint value (Pgen_AG_ref) for the power of an air gap of a generator of the wind power installation.

16. The wind power installation as claimed in claim 10, wherein the grid-side active inverter is controlled as a function of a setpoint-actual difference, from the setpoint value (Pgen_AG_ref) and an actual value (Pgen_AG_act) for the air gap of the generator of the wind power installation.

17. The wind power installation as claimed in claim 10, wherein at least one of:
the grid-side active inverter is controlled as a function of a power deviation (ΔPgrid_side_ref), or
the grid-side active inverter is controlled taking into account at least one of converter losses or losses in a stator of the generator.

18. The wind power installation as claimed in claim 10, wherein a negative energy buffer is provided for managing a grid-side power reduction, the negative energy buffer being a chopper in a DC link of the converter.

19. The wind power installation as claimed in claim 10, wherein the controller is further configured to generate a setpoint value (Igen-side-ref) for a current of the grid-side active inverter.
